(19) United States
(12) Patent Application Publication
(10) Pub. No.: US 2014/0135965 A1
(43) Pub. Date: May 15, 2014

(54) APPARATUS, SYSTEMS AND METHODS FOR PRODUCTION, DELIVERY AND USE OF EMBEDDED CONTENT DELIVERY

(71) Applicants: Carmi Raz, Tel Aviv (IL); Tomer Nahum, Tel Aviv (IL); Tomer Goldenberg, Vancouver (CA); Guy Eyal, Jerusalem (IL); Zvika Klier, Tel Aviv (IL); Tzahi Shneider, Lachish (IL); Avital Burgansky, Jerusalem (IL); Aharon Eyal, Jerusalem (IL)

(72) Inventors: Carmi Raz, Tel Aviv (IL); Tomer Nahum, Tel Aviv (IL); Tomer Goldenberg, Vancouver (CA); Guy Eyal, Jerusalem (IL); Zvika Klier, Tel Aviv (IL); Tzahi Shneider, Lachish (IL); Avital Burgansky, Jerusalem (IL); Aharon Eyal, Jerusalem (IL)

(73) Assignee: RE-10 LTD., Gizo (IL)

(21) Appl. No.: 14/115,211

(22) PCT Filed: Apr. 29, 2012
(86) PCT No.: PCT/IL12/50150

§ 371 Date: Jan. 24, 2014

Related U.S. Application Data
(60) Provisional application No. 61/481,481, filed on May 2, 2011.
(60) Provisional application No. 61/638,865, filed on Apr. 26, 2012.

(51) Int. Cl. G06F 17/30

(52) U.S. Cl. CPC G06F 17/30743
USPC 700/94

(57) ABSTRACT

A system comprising: (a) a transmitter adapted to provide an audio signal output comprising an embedded data element imperceptible to a human being of normal auditory acuity when said audio signal output is played through speakers wherein said embedded data element is embedded using phase modulation; and (b) an audio receiver adapted to receive said audio signal output and extract said embedded data element and respond to at least a portion of the data in said embedded data element.

### RELATED APPLICATIONS

In accordance with the provisions of 35 U.S.C. §119(e) and §363, this application claims the benefit of:

U.S. 61/481,481 filed 2 May 2011 by Carmi RAZ et al. and entitled “Apparatus, Systems and Methods for Production, Delivery and Use of Embedded Content Delivery”; and,

U.S. 61/638,865 filed 26 Apr. 2012 by Carmi RAZ et al. and entitled “Apparatus, Systems and Methods for Production, Delivery and Use of Embedded Content Delivery”; which is fully incorporated herein by reference.

### FIELD OF THE INVENTION

Various embodiments of the invention relate to an apparatus, systems and methods for embedding and/or extraction of data.

### BACKGROUND OF THE INVENTION

Modern society is increasingly dependent upon content delivery to portable devices such as laptop computers and mobile communication devices (e.g. mobile telephones and/or personal digital assistants). As a result, individuals are more accessible for delivery of content.

At the same time, content providers, including but not limited to advertisers, increasingly emphasize delivery of content to users that meet one or more predefined criteria.

Embedding of non-audio data in sound has been previously proposed as described in U.S. Pat. No. 7,505,823; U.S. Pat. No. 7,796,676; U.S. Pat. No. 7,796,978; U.S. Pat. No. 7,460,991; U.S. Pat. No. 7,461,136; U.S. Pat. No. 6,829,368 and US 2009/0067292. Embedding technology is also described in “Acoustic OFDM: Embedding High Bit-Rate Data in Audio” by Matsuoka et al. and in “Acoustic Data Transmission Based on Modulated Complex Lapped Transform” to Hwan Sik Yun el al. This list does not purport to be exhaustive. Each of these patents, applications and articles is fully incorporated herein by reference.

### SUMMARY OF THE INVENTION

One aspect of some embodiments of the invention relates to embedding of digital data in an audio signal (e.g. an analog audio signal) to produce sound having embedded content of a second type that is imperceptible to a human listener. Optionally, the audio signal is provided as part of a video stream. In some exemplary embodiments of the invention, the audio signal comprises a representation of the sound.

The embedded content may include one or more of text, graphics, a secondary audio signal and machine readable instructions (e.g. a hypertext link or barcode). In some exemplary embodiments of the invention, the embedded content includes a coupon redeemable by the recipient and/or advertising for a product.

Optionally, multiple copies of the same audio signal are provided to multiple recipients and the embedded content in each copy is different. In some exemplary embodiments of the invention, the embedded content is matched to specific recipients based upon an individual user profile. In some exemplary embodiments of the invention, the embedded content is matched to an estimated user demograph of the main content presented in the audio signal.

Another aspect of some embodiments of the invention, relates to embedding content in the audio signal using the phases of some frequencies of the audio signal when represented in the frequency domain. Optionally, the embedded data is a bit string or stream. Alternatively or additionally, each bit is optionally represented by a phase modulation of two or more different frequencies of the audio signal.

Some exemplary embodiments of the invention, relate to an apparatus for embedding of data in an audio signal to produce sound having embedded content.

Some exemplary embodiments of the invention, relate to an apparatus for separating embedded data from an audio signal to render the embedded content perceptible to a recipient. Optionally, the embedded content is presented to the user on the same device used to present the audio signal. Optionally, the embedded content is presented to the user on a different device than that used to present the audio signal.

Some exemplary embodiments of the invention, relate to a system for embedding of data in an audio signal to produce an audio signal having embedded content, transmitting the signal with embedded content to one or more recipients and separating and reading the embedded content from the audio signal to render the embedded content perceptible to the recipient(s). According to these embodiments, transduction of the audio signal containing the embedded content via speakers, produces sound containing the embedded content. As a result, re-transduction of the sound to an audio signal by a microphone produces an audio signal containing the embedded content.

Additional exemplary embodiments of the invention, relate to methods for embedding of data in an audio signal to produce sound having embedded content and/or transmitting the signal with embedded content to one or more recipients and/or separating (or reading) the embedded content from the audio signal to render the embedded content perceptible to the recipient(s).

In some exemplary embodiments of the invention, there is provided a system including: (a) a transmitter adapted to provide an audio signal output including an embedded data element imperceptible to a human being of normal auditory acuity when the audio signal output is played through speakers wherein the embedded data element is embedded using phase modulation; and (b) an audio receiver adapted to receive the audio signal output and extract the embedded data element and respond to at least a portion of the data in the embedded data element. In some embodiments, the system includes one or more -speakers on the transmitter which provide the audio signal output.

Alternatively or additionally, in some embodiments the system includes at least one microphone on the receiver which receives the audio signal output. Alternatively or additionally, in some embodiments the transmitter includes an embedding module adapted to embed data in the audio signal output. Alternatively or additionally, in some embodiments the system includes a processor capable of executing a synchronization process wherein a synchronization point is determined according to a probability score, representing the probability for existence of binary data in a signal frame started from the synchronization point. Alternatively or additionally, in some embodiments, determination of the synchronization point is a maximum or minimum determination of the probability score. Alternatively or additionally, in some embodiments the receiver responds by presentation of a media not included in the received audio signal output. Alternatively or additionally, in some embodiments the media is retrieved from a computer network for presentation. Alternatively or additionally, in some embodiments the receiver responds by operating an application or a program. Alternatively or additionally, in some embodiments, the application or program is included in the embedded data element. Alternatively or additionally, in some embodiments the application or program is not included in the embedded data element. Alternatively or additionally, in some embodiments the audio receiver responds to the embedded data element by communicating with an application or a program associated with a second media. Alternatively or additionally, in some embodiments the audio receiver responds to the embedded data element by at least one action selected from the group consisting of generating an operation command, closing an electric circuit to a device and operating a mechanical actuator. Alternatively or additionally, in some embodiments at least a portion of the data in the embedded data element is modified by searching the data in a table and replacing it with a corresponding value. Alternatively or additionally, in some embodiments the at least a portion of the data in the embedded data element is modified by use of the data as in input to a function, and wherein the output of the function is used for the response. Alternatively or additionally, in some embodiments said responding includes supplying an access code to a computer resource. Alternatively or additionally, in some embodiments the extracting of the embedded data element occurs automatically. Alternatively or additionally, in some embodiments said response to at least a portion of the data in the embedded data element is an automatic response. Alternatively or additionally, in some embodiments the receiver outputs a first digital representation of the audio signal output and a second digital representation of the embedded data element. Alternatively or additionally, in some embodiments said response includes sending the embedded data element with additional data to a database. Alternatively or additionally, in some embodiments the additional data includes the user identifying data and/or a user parameter. Alternatively or additionally, in some embodiments said database is an audience survey database. Alternatively or additionally, in some embodiments said audio signal is a portion of a broadcasted media wherein the receiver responds by providing a commercial related to the broadcasted media content. Alternatively or additionally, in some embodiments the transmitter and the receiver are combined in a single device. Alternatively or additionally, in some embodiments the system includes two or more devices wherein each of the two or more devices includes the transmitter and the receiver. Alternatively or additionally, in some embodiments the embedded data element includes identifying data of the audio signal's source. Alternatively or additionally, in some embodiments the synchronization point is determined by a process which includes:
(a) constructing plurality of frames each includes N consequent samples, each start at a different sample point;
(b) evaluate for each of the plurality of frames, a corresponding score representing a probability of binary data existence in the frame;
(c) defining a frame from the plurality of frames as a base frame according to a calculated maximum or minimum of the corresponding scores;
(d) determined the start sample point of the base frame as the synchronization point.
In some exemplary embodiments of the invention, there is provided an embedded signal generator including:
(a) a signal generator adapted to provide an audio signal output; and
(b) an embedding module adapted to embed data in the audio signal output; wherein the embedded data is imperceptible to a human being of normal auditory acuity when the audio signal output is played through speakers; wherein the embedding includes a phase modulation.

In some embodiments, the embedded data includes at least one bit, wherein each of said at least one bit is represented by the phase of more than one frequency of the audio signal. Alternatively or additionally, in some embodiments the data is an identifying data of the audio signal's source. Alternatively or additionally, in some embodiments the embedding module receives real time audio as an input. Alternatively or additionally, in some embodiments the embedding module causes a delay due to embedding ≦1 sec.

In some exemplary embodiments of the invention, there is provided a signal decoder including: (a) a receiver adapted to receive an audio signal; (b) an extraction module adapted to (i) determine a synchronization point according to a probability score, representing the probability for existence of binary data in a frame beginning at said synchronization point; and (ii) extract data embedded in the audio signal to produce an extracted data element; and (c) a response module adapted to respond to the extracted data element; wherein the data embedded in the audio signal includes the phase of at least one frequency of the audio signal. Alternatively or additionally, in some embodiments the determination of the synchronization point is according to a maximum or minimum determination of the score. Alternatively or additionally, in some embodiments, the determination of a synchronization point includes: (a) constructing plurality of frames each including N consequent samples, each starting at a different sample point; (b) evaluating for each of the plurality of frames, a corresponding score representing the probability of binary data existing in the frame; (c) defining a frame from the plurality of frames as a base frame according to a calculated maximum or minimum of the corresponding scores; (d) determining the start sample point of the base frame as the synchronization point. Alternatively or additionally, in some embodiments the signal decoder is provided on a portable memory. Alternatively or additionally, in some embodiments the receiver is a microphone. Alternatively or additionally, in some embodiments the extracted data element includes text.

In some exemplary embodiments of the invention, there is provided a data stream including: (a) data encoding an audio signal; and (b) data not encoding the audio signal embedded within the data encoding an audio signal which is acoustically imperceptible to a human being of normal auditory acuity when the audio signal is transduced via speakers; wherein the embedded data is provided using the phases of some frequencies of the audio signal when represented in the frequency domain. In some embodiments, the embedded data includes machine readable instructions. Alternatively or additionally, in some embodiments the embedded data includes a coupon. Alternatively or additionally, in some embodiments the embedded data includes at least one URL. Alternatively or additionally, in some embodiments data encoding the audio signal is provided as part of a video stream. Alternatively or additionally, in some embodiments the embedded data includes a bit string with each bit represented by a phase modulation of at least two different frequencies of the audio signal.

In some exemplary embodiments of the invention, there is provided a method for assimilation of data into an audio signal, including:
(a) partitioning the data to strings of a predetermined length;
(b) partitioning a digital representation of an audio signal in time domain into frames in a predetermined duration;
(c) transforming the frames into frames represented by a frequency domain;
(d) defining a group of frequencies;
(e) modulating the phase of the frequencies in a specific frame, from the frames represented in frequency domain, depending on bits from a specific binary string from the binary strings,
(f) repeating (e) for a group of frames from the frames represented in the frequency domain, wherein at least some of the repetitions occur within overlapping frames;
(g) transforming the frames represented in a frequency domain into new frames represented in the time domain, and;
(h) combining the new frames into a new digital representation of the audio signal.

In some embodiments, each of the bits is represented by the phase of more than one frequency of the audio signal. Alternatively or additionally, in some embodiments the data is an identifying data of the audio signal's source.

In some exemplary embodiments of the invention, there is provided a method for extracting data embedded in an audio signal by phase modulation, including: determining a synchronization point according to a probability score, representing the probability for existence of data string(s) in a signal frame started from the synchronization point. In some embodiments, the determination of the synchronization point employs a maximum or minimum determination of the score.

Alternatively or additionally, in some embodiments, the determining a synchronization point includes:
(a) constructing plurality of frames each including N consequent samples, each starting at a different sample point;
(b) evaluate for each of the plurality of frames, a corresponding score representing the probability of binary data existence in the frame;
(c) defining a frame from the plurality of frames as a base frame according to a calculated maximum or minimum of the corresponding scores;
(d) determining the start sample point of the base frame as the synchronization point.
   Alternatively or additionally, in some embodiments the audio signal includes a representation of the sound. Alternatively or additionally, in some embodiments the data includes an identifying data of the audio signal's source.

In some exemplary embodiments of the invention, there is provided a method for synchronizing an audio signal including data embedded therein by phase modulation, including: digitally sampling the audio signal to produce a plurality of samples; evaluating each of the plurality of samples as a potential synchronization point; and determining a time delay between repetitions of the embedded data according to the evaluation. In some embodiments, the audio signal includes a representation of the sound.

In some exemplary embodiments of the invention, there is provided a system for generating operation commands including: (a) an audio signal receiver; (b) a processor coupled to the receiver, the processor adapted to compare phase modulation characteristics of at least a portion of a received audio signal with a pre-stored database to produce at least one cue; and (c) a command generator configured to receive the at least one cue and communicate at least one command to an application based on the at least one cue.

In some exemplary embodiments of the invention, there is provided a method for generating a personalized content, including: receiving an audio signal at least partly representing the auditory environment of a portable electronic device; and embedding at least one user descriptive parameter in the audio signal using the phases of some frequencies of the audio signal when represented in the frequency domain.

In some embodiments, the user descriptive parameter includes a user profile in a social network or part of it and/or user data from a subscribed database and/or location and/or user age and/or user gender and/or user nationality and/or a user selected preference.

Unless otherwise defined, all technical and scientific terms used herein have the same meaning as commonly understood by one of ordinary skill in the art to which this invention belongs. Although suitable methods and materials are described below, methods and materials similar or equivalent to those described herein can be used in the practice of the present invention. In case of conflict, the patent specification, including definitions, will control. All materials, methods, and examples are illustrative only and are not intended to be limiting.

The phrase “adapted to” as used in this specification and the accompanying claims imposes additional structural limitations on a previously recited component.

As used in this specification and the accompanying claims, the term “binary data” indicates data encoded using 0 and 1 or other digital format. “Binary data” includes but is not limited to data encoded using ASCII.

As used herein, the terms “comprising” and “including” or grammatical variants thereof are to be taken as specifying inclusion of the stated features, integers, actions or components without precluding the addition of one or more additional features, integers, actions, components or groups thereof. This term is broader than, and includes the terms “consisting of” and “consisting essentially of” as defined by the Manual of Patent Examination Procedure of the United States Patent and Trademark Office.

The term “method” refers to manners, means, techniques and procedures for accomplishing a given task including, but not limited to, those manners, means, techniques and procedures either known to, or readily developed from known manners, means, techniques and procedures by practitioners of architecture and/or computer science.

Implementation of the method and system of the present invention involves performing or completing selected tasks or steps manually, automatically, or a combination thereof. Moreover, according to actual instrumentation and equipment of preferred embodiments of methods, apparatus and systems of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

In order to understand the invention and to see how it may be carried out in practice, embodiments will now be described, by way of non-limiting example only, with reference to the accompanying figures. In the figures, identical and similar structures, elements or parts thereof that appear in more than one figures are generally labeled with the same or similar references in the figures in which they appear. Dimensions of components and features shown in the figures are chosen primarily for convenience and clarity of presentation and are not necessarily to scale. The attached figures are:

FIG. 1 is a schematic representation of a system according to some exemplary embodiment of the invention;

FIG. 2 is a simplified flow diagram of a method according to some exemplary embodiments of the invention;

FIG. 3 is a simplified flow diagram of a method according to some exemplary embodiments of the invention;

FIG. 4 is a simplified flow diagram of a method according to some exemplary embodiments of the invention;

FIG. 5 is a simplified flow diagram of a method according to some exemplary embodiments of the invention;

FIG. 6 is a schematic representation of sampling according to some exemplary embodiments of the invention; and

FIG. 7 is a histogram of sound signal intensity and synchronization match value, each plotted as a function of time.

### DETAILED DESCRIPTION OF EMBODIMENTS

Embodiments of the invention relate to embedding data within an audio signal as well as to systems, methods and apparatus for such embedding and/or separation of embedded data from the audio signal.

Specifically, some embodiments of the invention can be used to deliver advertising content and/or coupons. Alternatively or additionally, some embodiments of the invention can be used for remote operation of computer programs or applications and/or remote operation of machinery or circuitry.

The principles and operation of systems, methods and apparatus according to exemplary embodiments of the invention may be better understood with reference to the drawings and accompanying descriptions.

Before explaining at least one embodiment of the invention in detail, it is to be understood that the invention is not limited in its application to the details set forth in the following description or exemplified by the Examples. The invention is capable of other embodiments or of being practiced or carried out in various ways. Also, it is to be understood that the phraseology and terminology employed herein is for the purpose of description and should not be regarded as limiting.

### Exemplary Data Stream

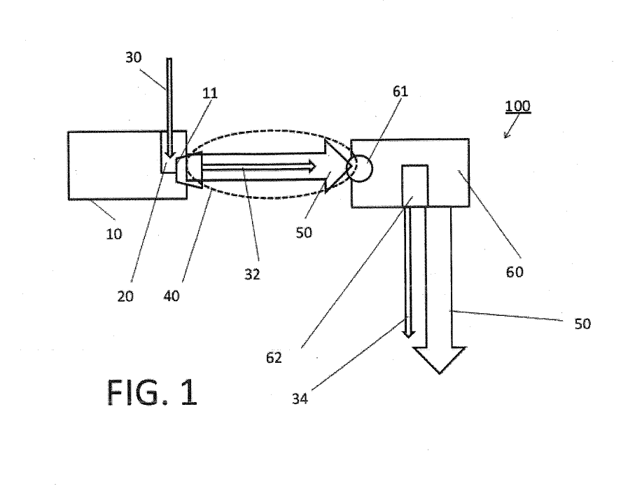

We refer now to FIG. 1, which is a schematic representation of a content delivery system indicated generally as 100: Some exemplary embodiments relate to a data stream 40, comprising data encoding an audio signal 50 and data 32 not encoding the audio signal embedded within data 50. According to many embodiments of the invention, data 32 is acoustically imperceptible to a human being of normal auditory acuity when audio signal 50 is transduced via speakers.

Optionally, embedded data 32 includes machine readable instructions. Machine readable instructions include, but are not limited to a barcode, a URL and lines of program code. In some exemplary embodiments of the invention, embedded data 32 includes a coupon or other advertising content.

Optionally, audio signal 50 is provided as part of a video stream. In some exemplary embodiments of the invention, embedded data 32 is provided using the phases of some frequencies of audio signal 50 when represented in the frequency domain. Optionally, embedded data 32 comprises a bit string with each bit represented by a phase modulation of two or more different frequencies of the audio signal.

Depicted exemplary system 100 includes a transmitter 10 adapted to provide an audio signal output 50 including an embedded data element 32 imperceptible to a human being of normal auditory acuity when the audio signal output is played through speakers. In some exemplary embodiments of the invention, embedded data element is embedded using phase modulation. Audio signal 50 and embedded data element 32 together are indicated as hybrid signal 40. Depicted exemplary system 100 includes audio receiver 60 adapted to receive hybrid audio signal output 40 and extract, or read, embedded data element 32 and respond to at least a portion of the data in embedded data element 32. In some exemplary embodiments of the invention, system 100 includes one or more speakers 11 on transmitter 10 which provide audio signal output 40 as sound. Alternatively or additionally, in some exemplary embodiments of the invention system 100 includes at least one microphone 61 on receiver 60 which receives audio signal output 40 as sound.

### Exemplary Embedding Algorithm

In some exemplary embodiments of the invention, the embedding employs a Modulated Complex Lapped Transform (MCLT). MCLT is a tool for localized frequency decomposition of audio signals. Optionally, MCLT contributes to a reduction in blocking artifacts and/or an increase in efficiency of reconstruction and/or an increase in computation speed.

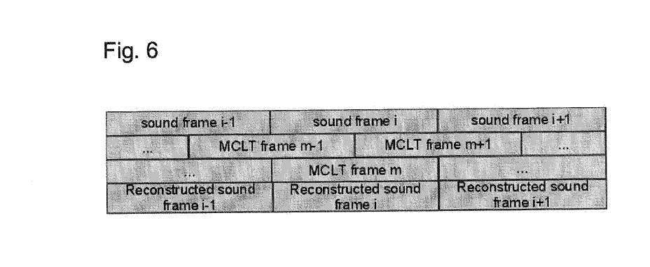

In those embodiments which employ MCLT, it is used to transform audio signal 50 to the frequency domain. According to these embodiments, sound is sampled and divided into frames with a selected length. Each MCLT frame overlaps it's neighboring frames by half its length (see FIG. 6). In some embodiments, data not related to audio signal 50 is encoded (e.g. by binary encoding such as ASCII) and embedded into the sound frames by altering the phase of the signal (in the frequency domain). For example, a phase of m is used in some embodiments to represent a bit with the value of 1, and a phase of 0 is used to represent a bit with the value of 0, at a given frequency. In some embodiments, MCLT and inverse MCLT conversion are applied to the signal. Optionally, correction of the output is performed by applying overlap from adjacent MCLT frames.

Extracting the embedded data (e.g. at an audio receiver), includes deciding if the sound signal phase (in the relevant frequency) is closer to π or 0. The digital or binary data (e.g. ASCII) is spread across a selected frequency bandwidth where every sample in the frequency domain represents one bit of data.

### Mathematics of MCLT

MCLT generates M coefficients from 2·M frame of input signal x(n).

The i^{th} input frame which is shifted by M is denoted by the following vector:

xᵢ=[x(i·M), x(i·M+1), . . . , x(i·M+2·M−1)]^{T}

The MCLT is given by:

Xᵢ=(C−jS)Wxᵢ, j=\sqrt{−1}

Where C(k,n), S(k,n) and W are defined as follows:

n=0,1, . . . , 2·M−1, k=0,1, . . . , M−1

$$C ( k , n ) = \sqrt{\frac{2}{M}} \cdot cos [ \frac{II}{M} \cdot ( n + \frac{M + 1}{2} ) \cdot ( k + \frac{1}{2} ) ]$$

$$S ( k , n ) = \sqrt{\frac{2}{M}} \cdot sin [ \frac{II}{M} \cdot ( n + \frac{M + 1}{2} ) \cdot ( k + \frac{1}{2} ) ]$$

$$w ( n ) = - sin [ \frac{II}{2 \cdot M} ( n + \frac{1}{2} ) ]$$

W is a 2·M×2·M diagonal matrix and w(n) is it's diagonal values.

The inverse MCLT is given by:

$${y}_{i} = \frac{W}{2} ( {C}^{T} {X}_{c , i} - {S}^{T} {X}_{s , i} ) , \\ X = {X}_{C , i} + {jX}_{s , i}$$

To obtain the reconstructed signal, the inverse MCLT frames are overlapped by M samples with adjacent MCLT frames.

$${\hat{y}}_{i} = [ \begin{matrix}{y}_{2 , i - 1} \\ … \\ O\end{matrix} ] + [ \begin{matrix}{y}_{1 , i} \\ … \\ {y}_{2 , i}\end{matrix} ] + [ \begin{matrix}O \\ … \\ {y}_{1 , i + 1}\end{matrix} ] , \\ {y}_{i} = [ \begin{matrix}{y}_{1 , i} \\ … \\ {y}_{2 , i}\end{matrix} ]$$

### Exemplary Embedding Mathematics

In some exemplary embodiments of the invention, the phase of the MCLT coefficients is modified to either π or 0 when received at a receiver. In some embodiments, only the coefficients in the relevant bandwidth are modified. In order to address interference by overlapping frames and the adjacent MCLT coefficients, “correction” of the phase at the transmitter is optionally employed to at least partially offset the anticipated interferences. In some exemplary embodiments of the invention, the data is embedded at every other MCLT coefficient. Optionally, use of every other MCLT coefficient contributes to efficiency of interference correction.

In some exemplary embodiments of the invention, phase is modified in the following way:

C=[C₁,C₂], S=[S₁,S₂],

$$W = [ \begin{matrix}{W}_{1} & O \\ O & {W}_{2}\end{matrix} ]$$

O is a M×M zero Matrix

A₋₁=C₁W₁W₂S₂^{T}, A₀=CWWS^{T}, A₁=C₂W₂W₁S₁^{T}

B₋₁=S₁W₁W₂C₂^{T}, B₀=SWWC^{T}, B₁=S₂W₂W₁C₁^{T}

$${X}_{c , i}^{′} ( k ) = [ {a}_{- 1 , k}^{T} {X}_{s , i - 1} + \frac{1}{2} {X}_{s , i} ( k - 1 ) - \frac{1}{2} {X}_{s , i} ( k + 1 ) + {a}_{1 , k}^{T} {X}_{s , i + 1} ] \cdot \vert {X}_{i} ( k ) \vert \cdot {d}_{l} ( k )$$

$${X}_{s , i}^{′} ( k ) = [ {b}_{- 1 , k}^{T} {X}_{c , i - 1} - \frac{1}{2} {X}_{c , i} ( k - 1 ) + \frac{1}{2} {X}_{c , i} ( k + 1 ) + {b}_{1 , k}^{T} {X}_{c , i + 1} ]$$

Where a_{1,k} and b_{1,k} are the k^{th} row of A₁ and B₁

d₁(k)∈|−1,1| depending on the binary data input.

k Represents a set of indexes corresponding to desired frequency bandwidth.

### Exemplary Embedding Apparatus

Referring again to FIG. 1: some exemplary embodiments of the invention relate to an embedded signal generator 10 including an embedding module 20 adapted to embed data 30 in audio signal output 50 to create a hybrid signal 40. As used in this specification and the accompanying claims, the term “hybrid signal” indicates an audio signal with additional data embedded therein using the phases of some frequencies of the audio signal when represented in the frequency domain. “Hybrid sound” indicates sound transduced from a hybrid signal (e.g. by one or more speakers). Signal generator 10 may be, for example, a broadcast transmitter (e.g. radio or television), an Internet server, a set top box, a laptop computer, a mobile telephone or a desktop personal computer. In some exemplary embodiments of the invention, embedding module 20 receives real time audio as an input. Optionally, embedding module 20 causes a delay due to embedding ≦1 sec. In many exemplary embodiments of the invention, embedded data 32 is imperceptible to a human being of normal auditory acuity when the audio signal 50 is played through speakers. Optionally, module 20 has access to user specific data and selects embedded data 30 based upon a user demograph and/or user preferences.

Optionally, embedding 20 relies upon phase modulation to embed data 32 in audio signal 50. Optionally, embedded data 32 comprises at least one bit, and each of the at least one bit is represented by the phase of more than one frequency of audio signal 50. In some exemplary embodiments of the invention, data 32 is an identifying data of the audio signal's (50) source.

### Exemplary Embedded Signal Decoding Apparatus

Referring again to FIG. 1: Some exemplary embodiments of the invention relate to an embedded signal decoder comprising a receiver 60 adapted to receive hybrid signal 40 (or hybrid sound transduced from hybrid signal 40) including audio signal 50 and embedded content 32, extraction module 62 adapted to determine a synchronization point according to a probability score, representing the probability for existence of binary data in a frame beginning at the point and extract data embedded in the audio signal to produce an extracted data element and a response module adapted to respond to extracted data element 34. In some exemplary embodiments of the invention, storage of extracted data element 34 in a memory serves as the response.

Although extracted data element 34 is depicted separately from audio signal 50 to emphasize the fact that the data can be used separately from audio signal 50, in some embodiments audio signal 50 leaving receiver 60 is still a hybrid signal 40 containing embedded data 32.

Optionally, data 32 embedded in audio signal 50 includes the phase of at least one frequency of the audio signal. Optionally, determination of the synchronization point is according to a maximum or minimum determination of the score.

In some exemplary embodiments of the invention, determination of a synchronization point includes:
(a) constructing plurality of frames each comprising N consequent samples, each starting at a different sample point;
(b) evaluating for each of the plurality of frames, a corresponding score representing the probability of binary data existing in the frame;
(c) defining a frame from the plurality of frames as a base frame according to a calculated maximum or minimum of the corresponding scores;
(d) determining the start sample point of the base frame as the synchronization point.

Optionally, apparatus 60 is provided on or in a portable memory (e.g. flash drive or SD RAM card). According to other embodiments of the invention apparatus 60 and/or module 62 are integrated into a mobile telephone and/or personal computer (e.g. laptop; desktop, tablet or phone). Alternatively or additionally, in some embodiments extracted data element 34 includes text.

In some exemplary embodiments of the invention, receiver 60 includes a microphone. According to these embodiments, hybrid sound transduced from hybrid signal 40 is “heard” by the microphone of receiver 60 as sound and re-transduced by the microphone to hybrid signal 40 which is read by extraction module 62 to make embedded data 32 available as extracted data element 34. In this way, embedded data 32 can be transferred from a first device as sound to a second device. Optionally, extracted data element 34 causes the second device including the microphone (e.g. a smartphone) to display content on its screen. In some embodiments, this content engages the user.

In some exemplary embodiments of the invention, receiver 60 is configured as an audio receiver, television or computer. According to these embodiments, hybrid signal 40 is read directly (i.e. without transduction to sound) by an extraction module 62 in the receiver to make embedded data 32 available as extracted data element 34 to another application in the same device. For example, a user listening to a music file containing embedded data 32 on a computer using an MP3 player program can see an advertisement for an upcoming live performance by the artist in an internet browser launched by extracted data element 34 on the same computer. Alternatively or additionally, the advertisement for an upcoming live performance by the artist may appear on the users smartphone as embedded data 32 is “heard” by the microphone of the smartphone in sound transduced from hybrid signal 40.

### Exemplary System

Referring again to FIG. 1, content delivery system 100 includes transmitter 10 as described hereinabove and a receiver 60 as described hereinabove. In some exemplary embodiments of the invention a processor in module 62 executes a synchronization process wherein a synchronization point is determined according to a probability score, representing the probability for existence of binary data in a signal frame started from the point. In some embodiments, binary data is embedded using phase modulation. Optionally, the determination of the point is a maximum or minimum determination of the score. In some exemplary embodiments of the invention, receiver 60 responds by presentation of a media not included in received audio signal output 50. Optionally, the media is retrieved from a computer network for presentation. According to various exemplary embodiments of the invention the computer network includes the Internet and/or one or more LANs and/or direct remote access (e.g. via FTP). Alternatively or additionally, receiver 60 responds by operating an application or a program. Optionally, the application or program is, or is not, included in embedded data element 32.

In some exemplary embodiments of the invention, receiver 60 responds to embedded data element 32 by communicating extracted data element 34 as an output signal to an application or a program associated with a second media.

In some exemplary embodiments of the invention, receiver 60 responds to embedded data element 32 by at least one action selected from the group consisting of generating extracted data element 34. According to various exemplary embodiments of the invention extracted data element 34 is used as an operation command and/or for closing an electric circuit to a device and/or for operating a mechanical actuator.

Optionally, at least a portion of data in extracted data element 34 is modified by searching data in a table and replacing it with a corresponding value.

Alternatively or additionally, at least a portion of the data in extracted data element 34 is modified by use of the data as in input to a function, and the output of function is used for a response. Optionally, responding includes supplying an access code to a computer resource (e.g. a network location e.g. a URL of an Internet resource) and/or a username and password).

In some exemplary embodiments of the invention, extracting, or reading, of embedded data element 32 occurs automatically.

Optionally, response to at least a portion of data in extracted data element 34 is an automatic response.

In some exemplary embodiments of the invention, embedded data element 32 is embedded in audio signal 50 by a phase modulation method without comprising power spread spectrum.

In some exemplary embodiments of the invention, receiver 60 outputs a first digital representation of signal 50 and extracted data element 34 as a second digital representation of embedded data element 32.

In some embodiments of system 100, determination of a synchronization point relies upon a synchronization process including:
(a) constructing plurality of frames each comprises N consequent samples, each start at a different sample point;
(b) evaluate for each of the plurality of frames, a corresponding score representing the probability of binary data existence in the frame;
(c) defining a frame from the plurality of frames as a base frame according to a calculated maximum or minimum of the corresponding scores;
(d) determining the start sample point of the base frame as the synchronization point.

Optionally, the response includes sending the extracted data element 34 with additional data to a database. Optionally, the additional data includes user identifying data and/or a user parameter. Optionally, the database is an audience survey database. Optionally, the audio signal is a portion of a broadcasted media and the receiver responds by providing a commercial related to the broadcasted media content.

In some exemplary embodiments of the invention, receiver 60 responds by generating an operation command and/or closing an electric circuit to a device responsive to extracted data element 34.

In some exemplary embodiments of the invention, transmitter 10 and receiver 60 are combined in a single device.

Optionally, system 100 includes two or more devices and each of the two or more devices comprises a transmitter 10 and a receiver 60.

Optionally, embedded data element 32 includes identifying data of audio signal's 50 sources.

### Exemplary Embedding Method

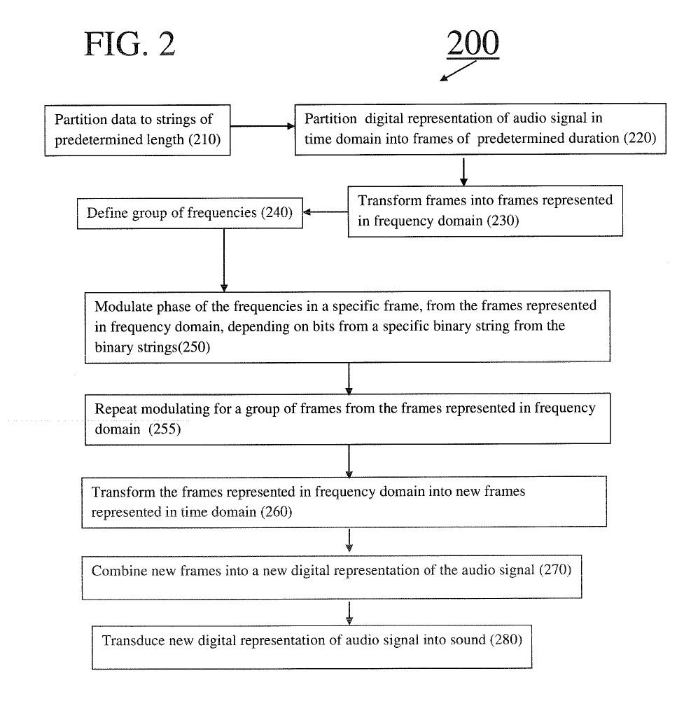

Referring now to FIG. 2, a method for assimilation of data into an audio signal is generally indicated as 200. Method 200 includes partitioning 210 data to strings (e.g. digital or binary strings) of a predetermined length, partitioning 220 a digital representation of an audio signal in time domain into frames in a predetermined duration, transforming 230 the frames into frames represented in frequency domain, defining 240 a group of frequencies, modulating 250 the phase of the frequencies in a specific frame, from the frames represented in frequency domain, depending on bits from a specific string from the strings, repeating 255 modulating 250 for a group of frames from the frames represented in frequency domain wherein at least some of the repetitions occur within overlapping frames, transforming 260 the frames represented in frequency domain into new frames represented in the time domain, combining 270 the new frames into a new digital representation of the audio signal. Optionally, method 200 includes and transducing 280 the new digital representation of the audio signal into sound. In some exemplary embodiments of the invention, the sound carries the embedded data strings. Optionally, each of the bits is represented by the phase of more than one frequency of the audio signal. Optionally, the data is an identifying data of the audio signal's source.

### Exemplary Method to Extract Embedded Data

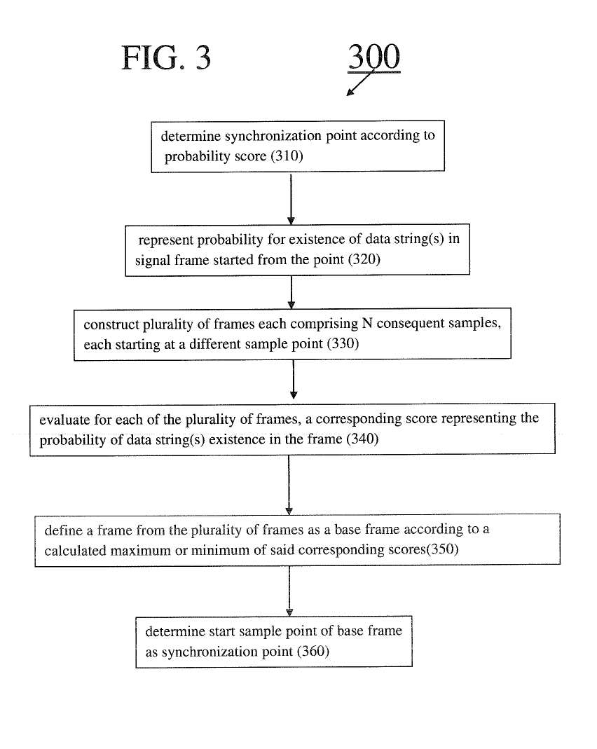

Referring now to FIG. 3, a method for extraction, or reading, of data from an audio signal is generally indicated as 300. Method 300 includes determining 310 a synchronization point according to a probability score and representing 320 the probability for existence of digital data string(s) (e.g. ASCII or other binary data strings) in a signal frame started from the point. In some exemplary embodiments of the invention, determination of the point employs a maximum or minimum determination of the score. Optionally, method 300 includes constructing 330 plurality of frames each comprising N consequent samples, each starting at a different sample point; evaluating 340 for each of said plurality of frames, a corresponding score representing said probability of data string existence in the frame; defining 350 a frame from the plurality of frames as a base frame according to a calculated maximum or minimum of the corresponding scores; and determining 360 the start sample point of the base frame as the synchronization point. Optionally, the audio signal is an acoustic signal or a representation of an acoustic signal. In some embodiments, the data includes an identifying data of the audio signal's source.

### Exemplary Synchronization Method

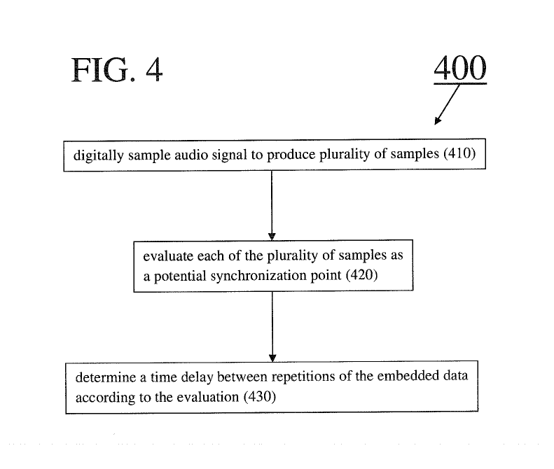

Referring now to FIG. 4, a method for synchronizing an audio signal comprising data embedded therein by phase modulation, is generally indicated as method 400. Method 400 includes digitally sampling 410 the audio signal to produce a plurality of samples; evaluating 420 each of the plurality of samples as optional potential synchronization point and determining 430 a time delay between repetitions of the embedded data according to the evaluation.

### Exemplary Synchronization Calculation Methods

According to various exemplary embodiments of the invention, synchronization is conducted during offline extraction or during real-time extraction. As used in this specification and the accompanying claims the term “offline extraction” indicates extraction performed on an audio signal stored in a memory (e.g. buffer). Optionally, offline extraction occurs without transducing the audio signal to sound. As used in this specification and the accompanying claims the term “real-time extraction” indicates extraction performed on an audio signal which is not stored in a memory. Optionally, online extraction is performed on an audio signal received as sound (e.g. via a microphone).

For offline extraction, time is less of a constraint. Reduction of the time constraint contributes to the feasibility of using an exhaustive search to move through the samples and look for the best synchronization match.

For real-time extraction, time is more of a constraint. Increasing the time constraint encourages limiting the number of match calculation per frame. In some embodiments, limiting the number of match calculation per frame contributes to an increase in calculation speed.

Alternatively or additionally, limiting the number of match calculation per frame contributes to an ability of the system to find a sync match after only a few frames. In some embodiments, after an initial match is found, interpolation is used to improve the match result and/or to achieve more accurate data extraction.

### Exemplary Synchronization Calculation Formula I

In some exemplary embodiments of the invention, synchronization includes calculation of the distance between the received phase, and the “optimal phase”.

$$match = 1 - \frac{1}{K} {\sum }_{k = {f}_{start}}^{{f}_{end}} \vert \vert \frac{Phase ( k )}{II} \vert - Round ( \vert \frac{Phase ( k )}{II} \vert ) \vert$$

Where {fₛₜₐᵣₜ, f_{end}} is the used bandwidth, K is the number of samples inside the bandwidth.

This exemplary synchronization formula can be used on every sample frame and does not lower the data bit rate. However, it may be difficult to get an accurate match, especially when large amounts of noise and distortion are present.

### Exemplary Synchronization Calculation Formula II

In some exemplary embodiments of the invention, synchronization includes calculation of a maximum correlation of a predetermined synchronization sequence,

$$match = 1 - \frac{1}{K} {\sum }_{k = {f}_{start}}^{{f}_{end}} \vert \vert \frac{Phase ( k )}{II} \vert - D ( k ) \vert$$

where D is a predetermined synchronization sequence that was embedded at the transmitter. In some exemplary embodiments of the invention, synchronization sequence D is embedded every few frames.

For example, in some embodiments synchronization sequence is embedded every 10 frames. If such an embodiment employs 44,100 samples per second, and every frame holds 1,024 samples, there are 4 synchronization sequences D per second.

This exemplary synchronization formula contributes to an ability of the system to achieve an acceptable synchronization match in the presence of noise and phase distortion. However, this exemplary synchronization formula contributes a reduction in the data bit rate and there are relatively few synchronization frames per second. Overall, synchronization using exemplary formula II may be slower than synchronization using exemplary formula I.

### Exemplary Synchronization Results

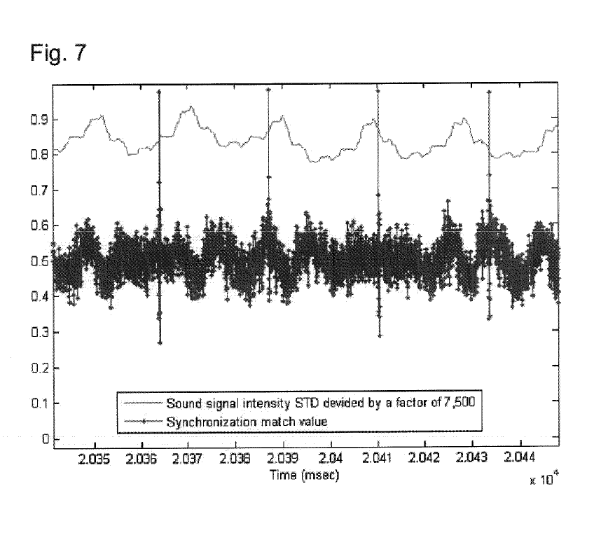

FIG. 7 is a histogram of sound signal intensity and synchronization match value each plotted as a function of time. Each frame included 1024 samples, and for each sync calculation, the frame was moved 1 sample.

### Additional Exemplary System

Referring again to FIG. 1, a system for generating operation commands content delivery system 100 includes audio signal receiver 60 equipped with processor 62 adapted to compare at least one characteristic of a received audio signal 50 with a pre-stored database and generate at least one cue from extracted data element 34 for transmission as a command to an application.

### Additional Exemplary Method

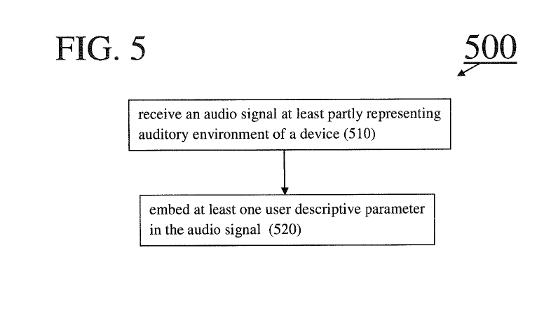

Referring now to FIG. 5, a method for generating personalized content is generally depicted as 500.

Depicted exemplary method 500 includes receiving 510 an audio signal at least partly representing the auditory environment of a portable electronic device and embedding 520 at least one user descriptive parameter in said audio signal using the phases of some frequencies of the audio signal when represented in the frequency domain.

In some embodiments, at least partly representing the auditory environment of the device includes using the phases of some frequencies of the audio signal when represented in the frequency domain.

According to various exemplary embodiments of the invention, the user descriptive parameter includes one or more of a user profile in a social network or part thereof, a user data from a subscribed database, location, user age, user gender, user nationality or user selected preference.

As an illustrative example of a possible implementation of method 500, the following scenario is presented. A driver of a car notices a strange noise emanating from the engine compartment when he starts his car in the morning. He takes out a smartphone with a data embedding installed. Using the application he records the engine noise while the car is in park then shifts into drive and begins to drive. Optionally, the driver adds voice comments to the recording such as “Even at 3500 RPM there doesn't seem to be any power.” After a few seconds, the application ceases recording, embeds at least one user descriptive parameter (e.g. license plate number) into the audio recording (optionally using phase modulation as described above) as embedded data 32 (FIG. 1) and sends the recording (e.g as an e-mail attachment) to an automotive service center pre-selected by the driver. At the automotive service center, the sound file is received and played back to produce an audio signal at least partly representing an auditory environment of a device (i.e. the driver's phone in this example). During playback automotive service center, an extraction module 62 (FIG. 1) reads the at least one user descriptive parameter received in the audio signal and generates content depending on the audio signal and the parameter. In this illustrative example the license plate number allows the service center to determine the make and model of the car as well as its service history. The audio signal itself is analyzed (either by a technician or by computer software) to determine the nature of the problem its severity and a proposed solution. This information can be returned to the driver (e.g via e-mail), optionally as an audio recording which can be listened to while driving.

### General Considerations

Referring again to FIG. 1, the scope of the invention is extremely broad so that hybrid audio signal 40 including embedded content 32 can be transmitted via a computer network (e.g. Internet or LAN) using protocols that rely on physical connections (e.g. Ethernet) and/or wireless communication protocols (e.g. WIFI, Bluetooth, Infrared) or via telephone (e.g. wire, cellular or satellite based systems) or television (e.g. broadcast television, cable TV or satellite TV) or radio (e.g. RF (AM or FM, optionally HD)).

As a result transmitter 10 is embodied by an internet server, a television or radio broadcast tower (or satellite), a set top box or a telephone switching network or mobile handset in various implementations of the invention.

Conversely, receiver 60 is embodied by a personal computer (e.g. desktop, laptop or tablet), mobile telephone, personal digital assistant or set top box in various implementations of the invention.

In some exemplary embodiments of the invention, receiver 60 outputs audio signal 50 to one application (e.g. an MP3 player application) and separated extracted data element 34 (previously embedded content 32) to a separate application (e.g. a web browser or graphics viewer).

In some exemplary embodiments of the invention, receiver 60 outputs audio signal 50 to one application (e.g. a Web browser) and separated content of extracted data element 34 (previously embedded content 32) to the same application (e.g. a pop-up window or additional tab in the web browser).

In some embodiments, embedded content 32 remains in output audio signal 50 from receiver 60. Representation of separated content of extracted data element 34 is for case of comprehension only. In those embodiments where embedded content 32 remains in output audio signal 50 it is substantially inaudible to a person of normal auditory acuity when signal 50 is transduced to sound by speakers.

### Exemplary Adaptations

Referring again to FIG. 1, in some embodiments, embedding module 20 is adapted to embed data 30 in audio signal output 50 to create a hybrid signal 40. This adaptation may include, but is not limited to, implementation of hardware and/or software and/or firmware components configured to perform MCLT as described hereinabove.

In some embodiments, receiver 60 is adapted to receive hybrid signal 40 including audio signal 50 and embedded content 32. In this case adaptation indicates that the receiver is compatible with the relevant signal transmitter.

In some embodiments, extraction module 62 is adapted to determine a synchronization point according to a probability score, representing the probability for existence of binary data in a frame beginning at the point and extract data embedded in the audio signal to produce an extracted data element. These adaptations include, but are not limited to implementation of hardware and/or software and/or firmware components configured to perform synchronization as described hereinabove.

In some embodiments, the response module is adapted to respond to extracted data element 34. According to various exemplary embodiments of the invention this adaptation includes implementation of hardware and/or software and/or firmware components configured to match the embedded data. For example, in embodiments in which the embedded data includes a URL, the response module includes a launch command for a WWW browser. Alternatively or additionally, in embodiments in which the embedded data includes a coupon as a graphics file (e.g. jpeg, tiff or bitmap), the response module includes a launch command for a graphics file reader capable of reading the relevant file format and displaying the coupon on a screen.

In some embodiments, audio signal receiver 60 is equipped with processor 62 adapted to compare at least one characteristic of a received audio signal 50 with a pre-stored database and generate at least one cue responsive to extracted data element 34 for transmission as a command to an application. This adaptation also relates to recognition of embedded content type and generation of cue responsive to extracted data element 34 in a machine readable form via software and/or firmware and/or hardware.

It is expected that during the life of this patent many new data transmission protocols will be developed and the scope of the invention is intended to include all such new technologies a priori.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

Each recitation of an embodiment of the invention that includes a specific feature, part, component, module or process is an explicit statement that additional embodiments not including the recited feature, part, component, module or process exist.

Specifically, a variety of numerical indicators have been utilized. It should be understood that these numerical indicators could vary even further based upon a variety of engineering principles, materials, intended use and designs incorporated into the invention. Additionally, components and/or actions ascribed to exemplary embodiments of the invention and depicted as a single unit may be divided into subunits. Conversely, components and/or actions ascribed to exemplary embodiments of the invention and depicted as sub-units/individual actions may be combined into a single unit/action with the described/depicted function.

Alternatively, or additionally, features used to describe a method can be used to characterize an apparatus and features used to describe an apparatus can be used to characterize a method.

It should be further understood that the individual features described hereinabove can be combined in all possible combinations and sub-combinations to produce additional embodiments of the invention. The examples given above are exemplary in nature and are not intended to limit the scope of the invention which is defined solely by the following claims. Specifically, the invention has been described in the context of delivery of text, graphics and machine readable instructions but might also be used to deliver embedded audio and or video content.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

The terms “include”, and “have” and their conjugates as used herein mean “including but not necessarily limited to”.

1. A system comprising:
(a) a transmitter adapted to provide an audio signal output comprising an embedded data element imperceptible to a human being of normal auditory acuity when said audio signal output is played through speakers wherein said embedded data element is embedded using phase modulation of some frequencies of the audio signal when represented in the frequency domain; and
(b) an audio receiver adapted to receive said audio signal output and extract said embedded data element and respond to at least a portion of the data in said embedded data element.

2-3. (canceled)

4. A system according to claim 1, wherein said transmitter comprises an embedding module adapted to embed data in said audio signal output.

5. A system according to claim 1, comprising a processor capable of executing a synchronization process wherein a synchronization point is determined according to a probability score, representing the probability for existence of binary data in a signal frame started from said point.

6-12. (canceled)

13. A system according to claim 1, wherein said audio receiver responds to said embedded data element by at least one action selected from the group consisting of generating an operation command, closing an electric circuit to a device and operating a mechanical actuator.

14. (canceled)

15. A system according to claim 1, wherein said at least a portion of the data in said embedded data element is modified by use of said data as in input to a function, and wherein the output of said function is used for said response.

16-25. (canceled)

26. A system according to claim 1, wherein said embedded data element includes identifying data of said audio signal's source.

27. A system according to claim 5, wherein said sychronization point is determined by a process comprising:
(a) constructing plurality of frames each comprises N consequent samples, each start at a different sample point;
(b) evaluate for each of said plurality of frames, a corresponding score representing a probability of binary data existence in said frame;
(c) defining a frame from said plurality of frames as a base frame according to a calculated maximum or minimum of said corresponding scores;
(d) determined the start sample point of said base frame as said synchronization point.

28. An embedded signal generator comprising:
(a) a signal generator adapted to provide an audio signal output; and
(b) an embedding module adapted to embed data in said audio signal output; wherein said embedded data is imperceptible to a human being of normal auditory acuity when said audio signal output is played through speakers; and wherein said embedding comprises a phase modulation of some frequencies of the audio signal when represented in the frequency domain.

29. A signal generator according to claim 28, wherein said embedded data comprises at least one bit, and wherein each of said at least one bit is represented by the phase of more than one frequency of said audio signal.

30. A signal generator according to claim 28, wherein said data is an identifying data of said audio signal's source.

31. A signal generator according to claim 28, wherein said embedding module receives real time audio as an input.

32. (canceled)

33. A signal decoder comprising:
(a) a receiver adapted to receive an audio signal;
(b) an extraction module adapted to determine a synchronization point according to a probability score, representing the probability for existence of binary data in a frame beginning at said point and extract data embedded in said audio signal to produce an extracted data element; and
(c) a response module adapted to respond to said extracted data element;
wherein said data embedded in said audio signal comprises the phase of at least one frequency of said audio signal.

34. A signal decoder according to claim 33, wherein said determination of said synchronization point is according to a maximum or minimum determination of said score.

35. A signal decoder according to claim 33, wherein said determination of a synchronization point comprises:
(a) constructing plurality of frames each comprising N consequent samples, each starting at a different sample point;
(b) evaluating for each of said plurality of frames, a corresponding score representing said probability of binary data existing in said frame;
(c) defining a frame from said plurality of frames as a base frame according to a calculated maximum or minimum of said corresponding scores;
(d) determining the start sample point of said base frame as said synchronization point.

36-44. (canceled)

45. A method for assimilation of data into an audio signal, comprising:
(a) partitioning said data to strings of a predetermined length,
(b) partitioning a digital representation of an audio signal in time domain into frames in a predetermined duration,
(c) transforming said frames into frames represented in frequency domain,
(d) defining a group of frequencies,
(e) modulating the phase of said frequencies in a specific frame, from said frames represented in frequency domain, depending on bits from a specific binary string from said binary strings,
(f) repeating (e) for a group of frames from said frames represented in frequency domain, wherein at least some of said repetitions occur within overlapping frames
(g) transforming said frames represented in frequency domain into new frames represented in the time domain, and
(h) combining said new frames into a new digital representation of said audio signal.

46. A method according to claim 45, wherein each of said bits is represented by the phase of more than one frequency of said audio signal.

47-57. (canceled)
